(19) United States
(12) Patent Application Publication
(10) Pub. No.: US 2009/0284543 A1
(43) Pub. Date: Nov. 19, 2009

(54) COMPUTER AND METHOD FOR PROCESSING IMAGES

(75) Inventor: Chi-Yi Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/436,131

(22) Filed: May 6, 2009

(30) Foreign Application Priority Data
May 16, 2008 (TW) 97118220

(51) Int. Cl. G09G 5/02; G06T 1/60

(52) U.S. Cl. 345/589; 345/522

(57) ABSTRACT

A computer having a CPU, a chipset and a graphic card is provided. The CPU is coupled to the graphic card through the chipset. The graphic card receives an output video from the chipset. The output video has a plurality of images, and each of the images has a plurality of pixels. The graphic card calculates the pixels of the image to obtain brightness values of the each pixels, and the brightness values are calculated to obtain brightness mapping values according to a non-linear function. Consequently, the graphic card is able to adjust a brightness contrast of each of the images so as to obtain a renewed output video.

### CROSS-REFERENCE TO RELATED APPLICATION

This application claims the priority benefit of Taiwan application serial no. 97118220, filed on May 16, 2008. The entirety of the above-mentioned patent application is hereby incorporated by reference herein and made a part of specification.

### BACKGROUND OF THE INVENTION

1. Field of the Invention

The present invention relates to a circuit and a method for processing images, and more particularly to a method for processing images suitable for graphic processing unit and a computer system corresponding to the circuit and the method.

2. Description of Related Art

In the conventional computer display technique, the central processing unit (CPU) is the primary executing and operating unit. In other words, when the computer system needs to display an image, the CPU has to compute and process various parameters of the image and send them to the monitor for display. Parameters of the image include brightness contrast, color saturation, and the like. Therefore, if a user wishes to adjust the parameters of a displayed image, or the computer automatically adjusts the parameters of the displayed image when a change in the surroundings is detected, the CPU needs to recalculate the parameters of the displayed image based on these requirements to generate the amended displayed image for the user.

As such, it requires considerable calculating power to compute various parameters of the displayed image. Generally, the CPU is more adapted to carrying out a logic computation. Hence, if a computer system is equipped with a CPU having more advanced functions, the computer system would be adequate for computing the parameters of the displayed image.

However, low-priced computer systems have emerged recently and taken up certain share of the market. Since the low-priced computers are not costly, entry-level CPUs are usually selected as the standard equipment for these low-priced computers in order to save fabrication costs. The entry-level CPUs may be adequate for carrying out normal operations of the computer system, but if these CPUs need to additionally compute and execute the parameters of the displayed image, such workload may exceed the capability of these CPUs, resulting in reduced speed and efficiency of data processing in the computer system.

### SUMMARY OF THE INVENTION

The present invention provides a circuit for processing images, and the circuit includes a video memory and a graphic processing unit. The video memory stores an output video, and the output video includes a plurality of images. Each of the plurality of images has a plurality of pixels. Moreover, the graphic processing unit may be coupled to the video memory. The graphic processing unit thereby extracts the images to calculate brightness values of each of the pixels and carry out a conversion computation on the brightness values of the pixels to obtain a plurality of corresponding brightness mapping values. At this moment, the graphic processing unit adjusts a brightness contrast of each image according to the brightness values and the brightness mapping values.

From another aspect, the present invention also provides a computer including a central processing unit (CPU), a chipset and a graphic card. The CPU is coupled to the graphic card through the chipset. Therefore, the graphic card receives an output video from the chipset, and the output video has a plurality of images. Each of the images has a plurality of pixels. The graphic card calculates the brightness values of each of the pixels and carries out a conversion computation of the brightness values of the pixels to obtain a plurality of brightness mapping values. Thus, the graphic card adjusts the brightness contrast of each of the images to obtain a renewed output video according to the brightness values and the brightness mapping values.

From another perspective, the present invention further provides a method for processing images. The method includes receiving an output video, and the output video has a plurality of images. Each of the images has a plurality of pixels. Moreover, the method further includes calculating brightness values of each of the pixels to carry out a conversion computation of the brightness values to obtain a plurality of brightness mapping values. Thus, the graphic card adjusts the brightness contrast of each of the images to obtain a renewed output video according to the brightness values and the brightness mapping values.

In the present invention, the graphic processing unit shares the burden of computing and executing the parameters of the images, and accordingly the amount of data processing is effectively reduced rendering the computation in the computer system more efficient.

To make the above and other objectives, features, and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a circuit block diagram of a computer according to a preferred embodiment of the present invention.

FIG. 2 shows a circuit block diagram of a circuit for processing images according to a preferred embodiment of the present invention.

FIG. 3 shows a configuration of the graphic processing unit according the first embodiment of the present invention.

FIG. 4 shows a process flow of the method for processing images according to the first embodiment of the present invention.

FIG. 5A shows a configuration of a contrast processing unit according to a preferred embodiment of the present invention.

FIG. 5B shows a configuration of a contrast processing unit according to another preferred embodiment of the present invention.

FIG. 6 shows a process flow of a method for adjusting brightness contrast of images according to a preferred embodiment of the present invention.

### DESCRIPTION OF EMBODIMENTS

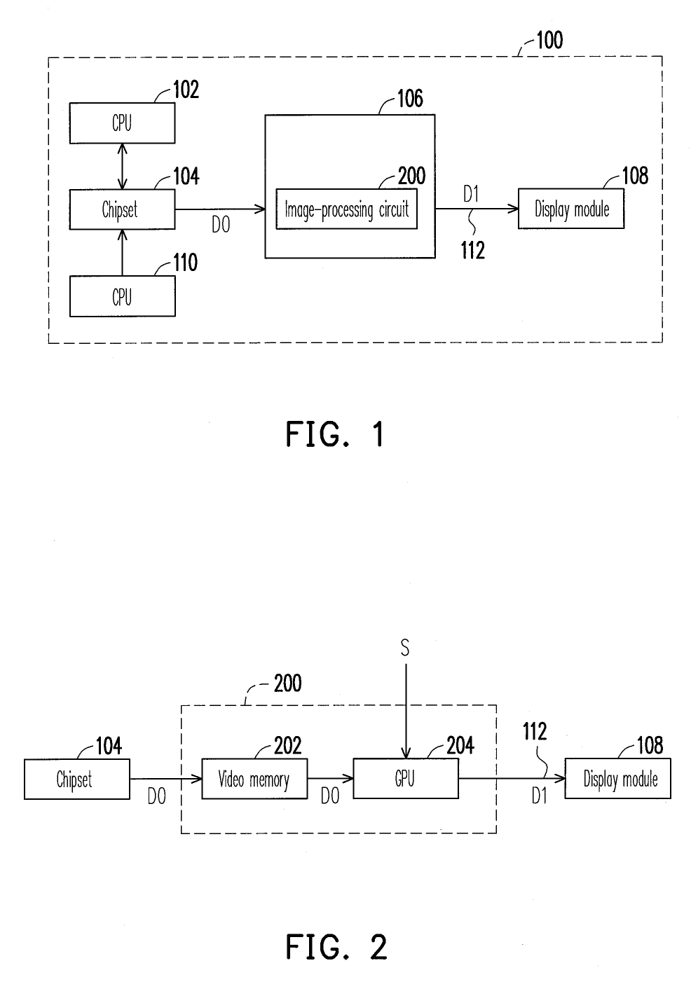

FIG. 1 shows a circuit block diagram of a computer according to a preferred embodiment of the present invention. Referring to FIG. 1, a computer 100 provided by the present embodiment includes a central processing unit (CPU) 102, a chipset 104, a graphic card 106, a display module 108 and a user input module 110. According to the present embodiment, the CPU 102 is coupled to the chipset 104 and coupled to the graphic card 106 and the user input module 110 through the chipset 104. Moreover, the graphic card 106 is coupled to the display module 108 through a data transmission interface 112. The data transmission interface 112 is a VGA interface, for example.

According to the present embodiment, the graphic card 106 has an image-processing circuit 200 capable of processing an output video D0. When the computer 100 displays an output video D1 from the display module 108, the chipset 104 may send the original output video D0 to the graphic card 106 for processing. Generally, the output video D0 has a plurality of images, and each of the images has a plurality of pixels.

FIG. 2 shows a circuit block diagram of a circuit for processing images according to a preferred embodiment of the present invention. Referring to FIG. 2, the image-processing circuit 200 provided by the present embodiment includes a video memory 202 and a graphic processing unit (GPU) 204. The video memory 202 is coupled to the chip set 104 and the GPU 204. An output of the GPU 204 is sent to the display module 108 through the data transmission interface 112. The GPU 204 adjusts a brightness contrast of each of the images or uniformizes a color value of each of the images according to an inputted parameter S. According to the present embodiment, the display module 108 includes a display, such as a liquid crystal display (LCD).

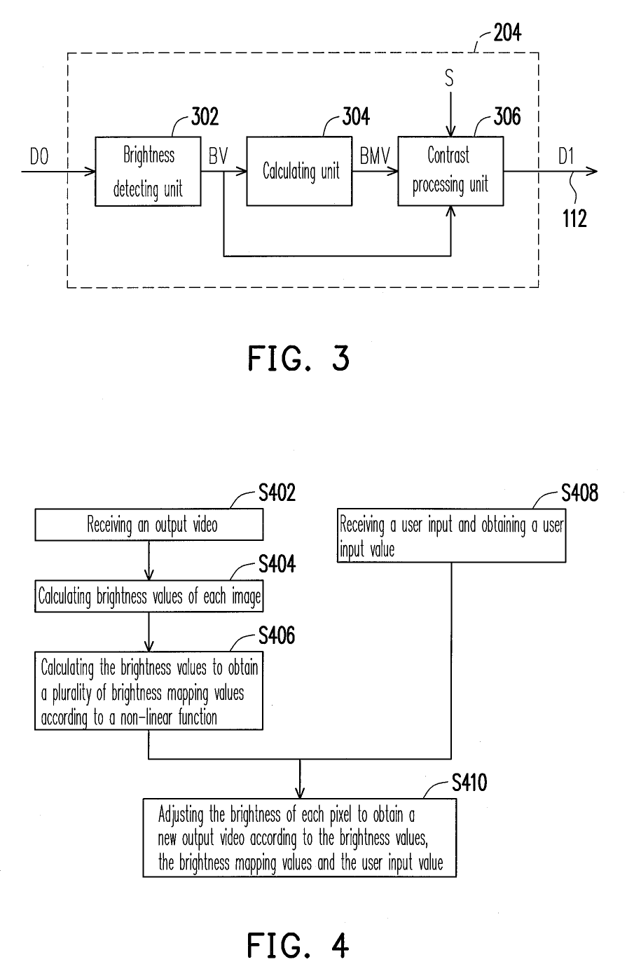

FIG. 3 shows a configuration of the GPU 204 according to a preferred embodiment of the present invention. FIG. 4 shows a process flow of a method for processing images according to a preferred embodiment of the present invention. Referring to both FIGS. 3 and 4, the configuration of the GPU provided by the present embodiment includes a brightness detecting unit 302, a calculating unit 304 and a contrast processing unit 306. The brightness detecting unit 302 is coupled to the video memory 202 in FIG. 2, and the output of the brightness detecting unit 302 is coupled to the calculating unit 304. In addition, the contrast processing unit 306 may also be coupled to the calculating unit 304, and the output of the contrast processing unit 306 is sent to the display module 108 through the data transmission interface 112.

Taking FIG. 3 for example, when the GPU 204 receives the original output video D0, as described in a step S402, the brightness detecting unit 302 first detects a brightness of each of the pixels in each image and obtains brightness values BV of each of the pixels, as described in a step S404. The brightness values BV are sent to the calculating unit 304 so that the calculating unit 304 executes a step S406. That is, the brightness values BV are calculated to obtain a plurality of brightness mapping values BMV according to a non-linear function to carry out a conversion computation. The non-linear function generally adopts a monotonic-rising non-linear function, such as a gamma function or variations of a gamma and hyperbolic tangent function. Afterwards, the brightness mapping values BMV may be sent to the contrast processing unit 306. Furthermore, the contrast processing unit 306 may also receive the brightness values BV. Thus, the contrast processing unit 306 adjusts the brightness contrast of each of the images to obtain a renewed output video D1 according to the brightness values BV and the brightness mapping values BMV.

According to other optional embodiments, the contrast processing unit 306 may also receive a user input value S generated by the user's operation of the user input module 110, as described in a step S408. The contrast processing unit 306 thereby adjusts the brightness contrast of each of the images, as described in a step S410, according to the brightness values BV, the brightness mapping values BMV and the user input value S. According to the present embodiment, the input module 110 is a keyboard or a mouse.

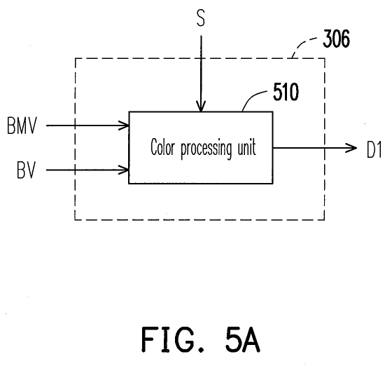

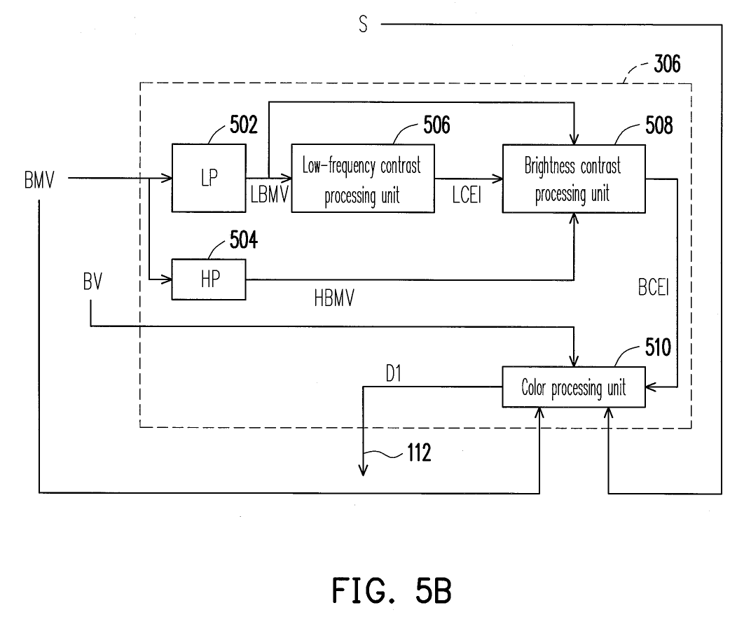

FIG. 5A shows a configuration of a contrast processing unit according to a preferred embodiment of the present invention. Referring to both FIGS. 3 and 5A, the contrast processing unit 306 provided in the present embodiment includes a color processing unit 510. An input of the color processing unit 510 is coupled to the brightness detecting unit 302 and the calculating unit 304 to receive the brightness values BV and the brightness mapping values BMV. According to the present embodiment, the color processing unit 510 uses a following formula to obtain the renewed output video D1:

$$( \frac{B M V}{B V} ) \times I$$

Additionally, if considering the user input value S, the color processing unit 510 may use a following formula instead to generate the renewed output video D1:

$$[ ( 1 - S ) + S ( \frac{B M V}{B V} ) ] \times I$$

FIG. 5B shows a configuration of the contrast processing unit 306 according to another preferred embodiment of the present invention. Referring to FIGS. 3 and 5B, the contrast processing unit 306 provided by the present embodiment includes a low-pass (LP) filter 502, a high-pass (HP) filter 504, a low-frequency contrast processing unit 506 and a brightness contrast processing unit 508. The low-pass filter 502 and the high-pass filter 504 are both coupled to the calculating unit 304 to receive the brightness mapping values BMV. After the high-pass filter 504 receives the brightness mapping values BMV, a plurality of high-pass brightness mapping values (HBMV) is generated. Moreover, the low-pass filter 502 outputs a plurality of low-pass brightness mapping values (LBMV) to the low-frequency contrast processing unit 506 to generate a plurality of low-frequency contrast processing signals (LCEI). The input of the brightness contrast processing unit 508 is coupled to the output of the low-pass filter 502, the high-pass filter 504 and the low-frequency contrast processing unit 506 so as to generate a plurality of brightness contrast processing signals (BCEI). The contrast processing unit 306 further includes the color processing unit 510. The input of the color processing unit 510 is coupled to the output of the brightness contrast processing unit 508. After receiving the brightness values BV and the brightness contrast processing signals BCEI, the color processing unit 510 outputs a renewed output video D1. At this moment, the color processing unit 510 may also receive a parameter S inputted by a user to adjust a brightness contrast of each of the images or uniformize a color value of each of the images.

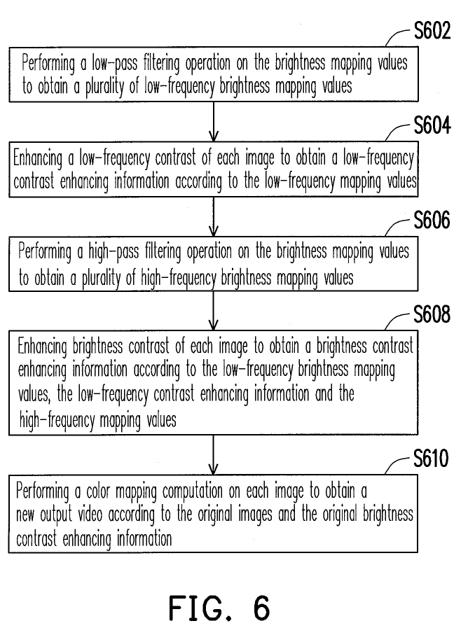

FIG. 6 shows a process flow of a method for adjusting brightness contrast of images according to a preferred embodiment of the present invention. Referring to FIGS. 5B and 6, when the brightness mapping values BMV are sent to the contrast processing unit 306, the low-pass filter 502 carries out a low-pass filtering operation on the brightness mapping values BMV to obtain a plurality of low-frequency brightness mapping values LBMV sent to the low-frequency contrast processing unit 506, as described in a step S602. Currently, the low-frequency contrast processing unit 506 enhances a low-frequency contrast of each of the images according to a following formula to obtain a low-frequency contrast enhancing information (LCEI), as described in a step S604. The mathematical formula is expressed as follows:

$${\vert \frac{B V - L B M V}{255} \vert}^{k 1} \times sign ( B V - L B M V ) , k 1 = 0 \sim 1$$

Sign(x) represents the sign of the variable x.

On the other hand, the high-pass filter 504 carries out a high-pass filtering operation on the brightness mapping values BMV to obtain a plurality of high-frequency brightness mapping values HBMV, as described in a step S606. Thus, the brightness contrast processing unit 508 enhances a brightness contrast of each of the images to obtain the brightness contrast enhancing information BCEI according to the low-frequency brightness mapping values LBMV, the low-frequency contrast enhancing information LCEI and the high-frequency brightness mapping values HBMV, as described in a step S608. According to the present embodiment, the brightness contrast processing unit 508 uses a following formula to obtain the brightness contrast enhancing information BCEI:

LBMV+LCEI+k2×HBMV, k2=0˜1

Additionally, if considering the user input value S, the following formula may use to generate the brightness contrast enhancing information BCEI:

LBMV+S×(LCEI+k2×HBMV), k2=0˜1

Furthermore, the output of the brightness contrast processing unit 508 is sent to the color processing unit 510. At this moment, the color processing unit 510 carries out a color mapping computing operation on each of the images to uniformize the color of each of the images and obtain the renewed output video D1 according to the original images and the brightness contrast enhancing information BCEI, as described in a step S610. According to the present embodiment, the color processing unit 510 uses a following formula to obtain the renewed output video D1:

$$( \frac{k 3 \times B C E I + ( 1 - k 3 ) \times B M V}{B V} ) \times I , k 3 = 0 \sim 1$$

In addition, if considering the user input value S, the color processing unit 510 may use a following formula instead to generate the renewed output video D1:

$$[ ( 1 - S ) + S ( \frac{k 3 \times B C E I + ( 1 - k 3 ) \times B M V}{B V} ) ] \times I , k 3 = 0 \sim 1$$

In summary, according to the present invention, the graphic processing unit is used to share the task of displaying images. Therefore, even if the computer uses an entry-level CPU, various kinds of processing and computations may still be carried out on the images without lowering the efficiency of the computer in processing the data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A circuit for processing images, comprising:
a video memory, used for storing an output video, wherein the output video comprises a plurality of images, and each of the images has a plurality of pixels; and
a graphic processing unit, coupled to the video memory and used for extracting the images to calculate a plurality of brightness values of each of the pixels respectively and perform a conversion computation of the brightness values to obtain a plurality of corresponding brightness mapping values so that the graphic processing unit adjusts a brightness contrast of each of the images according to the brightness values and the brightness mapping values.

2. The circuit for processing images of claim 1, wherein the graphic processing unit further adjusts the brightness contrast of each of the images according to an inputted parameter.

3. The circuit for processing images of claim 1, wherein the graphic processing unit further uniformizes a color value of each of the images according to another inputted parameter.

4. The circuit for processing images of claim 1, wherein the graphic processing unit further comprises:
a brightness detecting unit, receiving the images to generate the brightness values of each of the pixels;
a calculating unit, performing a conversion computation of the brightness values of the pixels to obtain the corresponding brightness mapping values; and
a contrast processing unit, adjusting the brightness contrast of each of the images with the brightness values and the brightness mapping values.

5. The circuit for processing images of claim 4, wherein the contrast processing unit further comprises:
a low-pass filter, outputting a plurality of low-pass brightness mapping values after receiving the brightness mapping values;
a high-pass filter, outputting a plurality of high-pass brightness mapping values after receiving the brightness mapping values;
a low-frequency contrast processing unit, outputting a plurality of low-frequency contrast processing signals after receiving the low-pass brightness mapping values;
a brightness contrast processing unit, outputting a plurality of brightness contrast processing signals after receiving the low-frequency contrast processing signals, the low-pass brightness mapping values and the high-pass brightness mapping values; and
a color processing unit, outputting a renewed output video after receiving the brightness values and the brightness contrast processing signals.

6. The circuit for processing images of claim 1, wherein the contrast processing unit further comprises:
a color processing unit, outputting a renewed output video after receiving the brightness values and the brightness mapping values.

7. A computer, comprising:
a central processing unit (CPU);
a chipset, coupled to the CPU; and
a graphic card, coupled to the chipset and used for receiving an output video from the chipset, the output video comprising a plurality of images, each of the images having a plurality of pixels, wherein the graphic card calculates brightness values of each of the pixels respectively to perform a conversion computation of the brightness values of the pixels and obtain a plurality of brightness mapping values so that the graphic card adjusts a brightness contrast of each of the images to obtain a renewed output video according to the brightness values and the brightness mapping values.

8. The computer of claim 7, wherein the graphic card comprises:
a video memory, coupled to the chipset and used for registering the output video; and
a graphic processing unit, coupled to the video memory and used for calculating the brightness value of each of the pixels so that the brightness contrast of each of the images is adjusted to generate the renewed output video according to the brightness values and the brightness mapping values.

9. The computer of claim 8, wherein the graphic processing unit further comprises:
a brightness detecting unit, receiving the images to generate the brightness values of each of the pixels;
a calculating unit, performing a conversion computation of the brightness values of the pixels to obtain the corresponding brightness mapping values; and
a contrast processing unit, adjusting the brightness contrast of each of the images with the brightness values and the brightness mapping values.

10. The computer of claim 9, wherein the contrast processing unit further comprises:
a low-pass filter, outputting a plurality of low-pass brightness mapping values after receiving the brightness mapping values;
a high-pass filter, outputting a plurality of high-pass brightness mapping values after receiving the brightness mapping values;
a low-frequency contrast processing unit, outputting a plurality of low-frequency contrast processing signals after receiving the low-pass brightness mapping values;
a brightness contrast processing unit, outputting a plurality of brightness contrast processing signals after receiving the low-frequency contrast processing signals, the low-pass brightness mapping values and the high-pass brightness mapping values; and
a color processing unit, outputting the renewed output video after receiving the brightness values and the brightness contrast processing signals.

11. The computer of claim 9, wherein the contrast processing unit further comprises:
a color processing unit, outputting a renewed output video after receiving the brightness values and the brightness mapping values.

12. The computer of claim 7, further comprising a display module coupled to the graphic card and used for displaying the renewed output video.

13. The computer of claim 7, further comprising a user input module coupled to the chipset through a transmission interface so that the user input module inputs a parameter.

14. The computer of claim 13, wherein the graphic card uniformizes colors of each of the images according to the parameter.

15. The computer of claim 13, wherein the graphic card adjusts a brightness contrast of each of the images further according to the parameter.

16. A method for processing images, comprising:
receiving an output video, the output video having a plurality of images, each of the images having a plurality of pixels respectively;
calculating a plurality of brightness values of each of the pixels;
performing a conversion computation of the brightness values to obtain a plurality of brightness mapping values; and
adjusting a brightness contrast of each of the images to obtain a renewed output video according to the brightness values and the brightness mapping values.

17. The method for processing images of claim 16, further comprising:
receiving a user input value; and
adjusting the brightness contrast and colors of the images according to the brightness values, the brightness mapping values and the user input value.

18. The method for processing images of claim 16, wherein the step of adjusting the brightness contrast of the images comprises:
performing a low-pass filtering operation on the brightness mapping values to obtain a plurality of low-pass brightness mapping values;
adjusting the brightness contrast of each of the images to obtain a plurality of low-frequency contrast processing signals according to the low-pass brightness mapping values;
performing a high-pass filtering operation on the brightness mapping values to obtain a plurality of high-pass brightness mapping values; and
performing a brightness contrast processing operation on each of the images to generate a plurality of brightness contrast processing signals so as to adjust a brightness contrast of each of the images according to the low-pass brightness mapping values, the low-frequency contrast processing signals and the high-pass brightness mapping values.

19. The method for processing images of claim 18, further comprising performing a color mapping calculation to uniformize a brightness and colors of each of the images according to the brightness values and the brightness contrast processing signals.
